(19) United States
(12) Patent Application Publication
(10) Pub. No.: US 2012/0130969 A1
(43) Pub. Date: May 24, 2012

(54) GENERATING CONTEXT INFORMATION FOR A SEARCH SESSION

(75) Inventors: SANDY WONG, SEATTLE, WA (US); RAVIPAL SINGH SOIN, KIRKLAND, WA (US); MAREK FRANCISZEK LATUSKIEWICZ, KIRKLAND, WA (US); JUN YIN, KIRKLAND, WA (US); DERRICK LESLIE CONNELL, SEATTLE, WA (US); ANDREW WILSON SHUMAN, SEATTLE, WA (US)

(73) Assignee: MICROSOFT CORPORATION, REDMOND, WA (US)

(21) Appl. No.: 12/949,462

(22) Filed: Nov. 18, 2010

(51) Int. Cl. G06F 17/30

(52) U.S. Cl. 707/706; 707/769; 707/E17.108

(57) ABSTRACT

Methods, systems, and computer-readable media for providing an enhanced search experience to a user by determining a user's presumptive intentions for an ongoing search session. A user's activities during the search session reveal clues to the user's intent for the search session. Embodiments of the present invention assign values to various context characteristics by analyzing the user's activities during a search session. The context characteristics describe different manifestations of user intent revealed by the user's actions. Embodiments of the present invention distribute the context information to applications that consume the context information and provide enhanced search results. This allows multiple context-based applications to have access to context information without accessing signal data or needing to independently process the signal data to determine an intent of the search session.

### BACKGROUND

Search engines or search websites generate a set of search results that are responsive to a search query. Search engines attempt to select the most responsive documents, videos, pictures, and web pages for inclusion in the search results. Some search engines allow users to sign into the search engine and create a user profile that includes their interests and demographic information. This information from the user's profile may be used to tailor the search results to be responsive to the specific user.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide an enhanced search experience by determining a user's presumptive intentions for an ongoing search session. In general, a user may have a different intent each time the user navigates to an online search engine and begins searching. For example, a user may intend to shop for books during a first search session and intend to plan a vacation during a second search session. A user's activities during the search session reveal clues to the user's intent for the search session. Embodiments of the present invention assign values to various context characteristics by analyzing the user's activities during a search session. The context characteristics describe different manifestations of user intent revealed by the user's actions. Search engines or other applications may use the context characteristics to provide enhanced search features that anticipate the user's intent for the search session.

Embodiments of the present invention facilitate the accurate assignment of values to context characteristics by collecting and storing information related to the user's activities during the search session (hereafter “signals”). The signals may be analyzed in combination with each other during the search session to assign values to context characteristics. Non-search-session information about a user, such as a prior browsing history or user profile information, may be used in combination with the signal data to generate context characteristics. However, embodiments of the present invention may rely solely on the signal data gathered during a search session.

Embodiments of the present invention distribute the context information to applications that consume the context information and provide enhanced search results. This allows multiple context-based applications to have access to context information without accessing signal data or needing to independently process the signal data to determine an intent of the search session.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an computing system architecture suitable for generating context characteristics describing a search session, in accordance with an embodiment of the present invention;

FIG. 3 is a diagram of a search-results page generated without using context characteristics to rank results based on proximity to a geographic location of interest, in accordance with an embodiment of the present invention;

FIG. 4 is a diagram of a search-results page that has enhanced search results 420 generated by adjusting a relevance rank based on a specific location, in accordance with an embodiment of the present invention;

FIG. 5 is a diagram of a search-results page that does not show a shopping comparison feature, in accordance with an embodiment of the present invention;

FIG. 6 is a diagram of a search-results page displaying a comparison shopping feature generated with context characteristics, in accordance with an embodiment of the present invention;

FIG. 7 is a diagram of a search-results page generated without the use of context characteristics, in accordance with an embodiment of the present invention;

FIG. 8 is a diagram of a search-results page enhanced by an in-stock search result feature, in accordance with an embodiment of the present invention;

FIG. 9 is a diagram of typical weather results generated without use of context characteristics, in accordance with an embodiment of the present invention;

FIG. 10 is a diagram of a of context-sensitive weather results, in accordance with an embodiment of the present invention;

FIG. 11 is a diagram of a search-results page showing nondisambiguated search results, in accordance with an embodiment of the present invention;

FIG. 12 is a diagram of a search-results page of disambiguated query results, in accordance with an embodiment of the present invention;

FIG. 13 is a flow chart showing a method of developing context information based on signals received during a search session, in accordance with an embodiment of the present invention;

FIG. 14 is a flow chart showing a method of providing context-sensitive features, in accordance with an embodiment of the present invention; and

FIG. 15 is a flow chart showing a method of generating context-sensitive features using context characteristics of a search session, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an enhanced search experience by determining a user's presumptive intentions for an ongoing search session. In general, a user may have a different intent each time the user navigates to an online search engine and begins searching. For example, a user may intend to shop for books during a first search session and intend to plan a vacation during a second search session. A user's activities during the search session may reveal clues to the user's intent for the search session. Embodiments of the present invention assign values to various context characteristics by analyzing the user's activities during a search session. These context characteristics describe different aspects of a user's intent. Search engines or other applications may use the context characteristics to provide enhanced search features that anticipate the user's intent for the search session.

Embodiments of the present invention facilitate the accurate assignment of context characteristics by collecting and storing information related to the user's activities during the search session (hereafter “signals”). The signals may be analyzed in combination with each other during the search session to populate and update context characteristics. Non-search-session information about a user, such as a prior browsing history or user profile information, may be used in combination with the signal data to generate context characteristics. However, embodiments of the present invention may rely solely on the signal data gathered during a search session.

The information gathered during the search session is analyzed and used to define one or more context characteristics of the search session. In one embodiment, values are assigned to a predefined set of context characteristics. In other words, the same context characteristics may be used in each search session, but different values are assigned to the context characteristics based on analysis of the signals received. An individual context characteristic may be associated with one or more values. At the beginning of the search session, the context characteristics may be blank. Upon receiving a first signal, a value may be assigned to one, two, or more of the characteristics as appropriate. Throughout this application, the process of assigning values to context characteristics may alternatively be referred to as generating context characteristics.

As stated, examples of context characteristics include a location of interest, an intended task, task-specific data, and entity data. In brief, the location of interest is a location the user shows an interest in through search queries or selected search results. The intended task may be shopping, traveling, comparing products, planning a night out, or other “real world task” the user is attempting to complete with the assistance from information retrieved using a search engine. The task-specific data may be data entered into forms, travel dates, travel origin, travel destination, and other information. The entity data includes people, places, and things such as artists, autos, movies, celebrities, and politicians.

Embodiments of the present invention distribute the context information to applications that consume the context information and provide enhanced search results. This allows multiple context-based applications to have access to context information without having access to signal data or needing to independently process the signal data to determine an intent of the search session.

Accordingly, in one embodiment, one or more computer-readable storage media having computer-executable instructions embodied thereon that when executed by a computing device perform a method of developing context information based on signals received during a search session. The method comprises determining that a user has initiated a search session. The search session comprises a series of activities associated with online searching of Internet content. The method also comprises receiving a plurality of signals associated with one or more activities performed during the search session. The method also comprises generating, at the computing device, a value for one or more context characteristics for the search session by analyzing the plurality of signals. The method also comprises exposing the one or more context characteristics and associated values to one or more applications that use context information to generate a context-sensitive feature.

In another embodiment, a method of providing context-sensitive features. The method comprises receiving a search query from a user. The method comprises initiating signal collection for the user's activities during a search session. The method also comprises generating, at a computing device, context-characteristic values for the search session using only signals collected during the search session. The method also comprises generating, at a computing device, a context-sensitive feature using the context-characteristic values. The method also comprises communicating a set of search results that are responsive to the search query and include the context-sensitive feature.

In one embodiment, one or more computer-readable storage media having computer-executable instructions embodied that when executed by a computing device perform a method of generating context-sensitive features using context characteristics of a search session. The receiving context-characteristic values for a search session being conducted by a user. The context-characteristic values are based on signal data associated with one or more activities performed during the search session. The method also comprises receiving a search query from a search engine. The method also comprises determining that one or more of the context characteristic values, in combination with the search query, allow a context-specific feature to be generated. The method also comprises generating the context-sensitive feature and communicating the context-sensitive feature to the search engine for display to the user as part of search results that are responsive to the search query.

Having briefly described an overview of embodiments of the invention, an exemplary operating environment suitable for use in implementing embodiments of the invention is described below.

### Exemplary Operating Environment

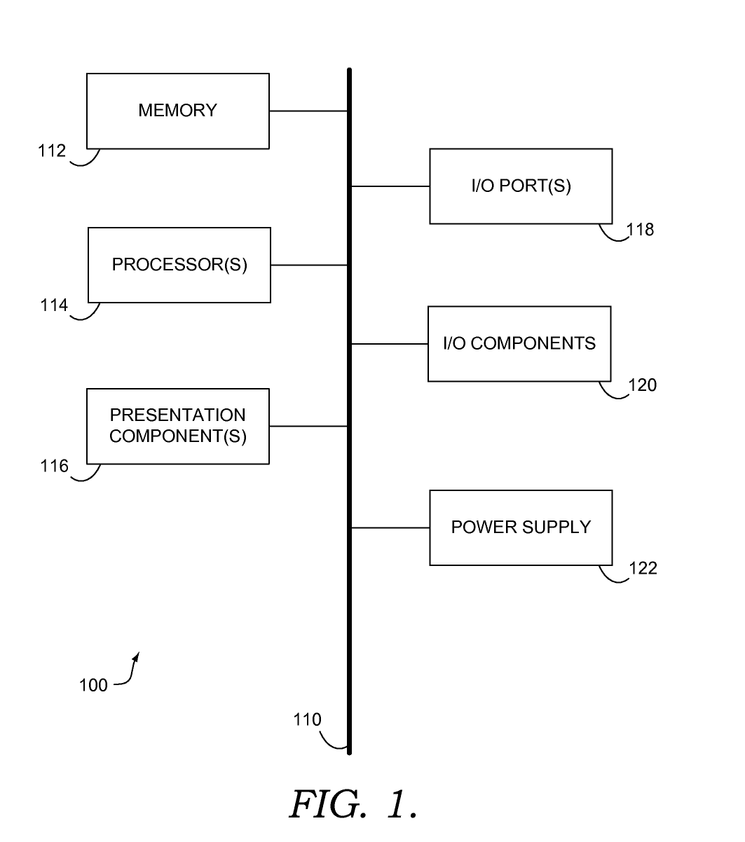

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120t. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable storage media. By way of example, computer-storage media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices; or any other medium that can be used to encode desired information and be accessed by computing device 100. The computer-readable storage media may be non-transitory.

Memory 112 includes computer-storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112, or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary System Architecture

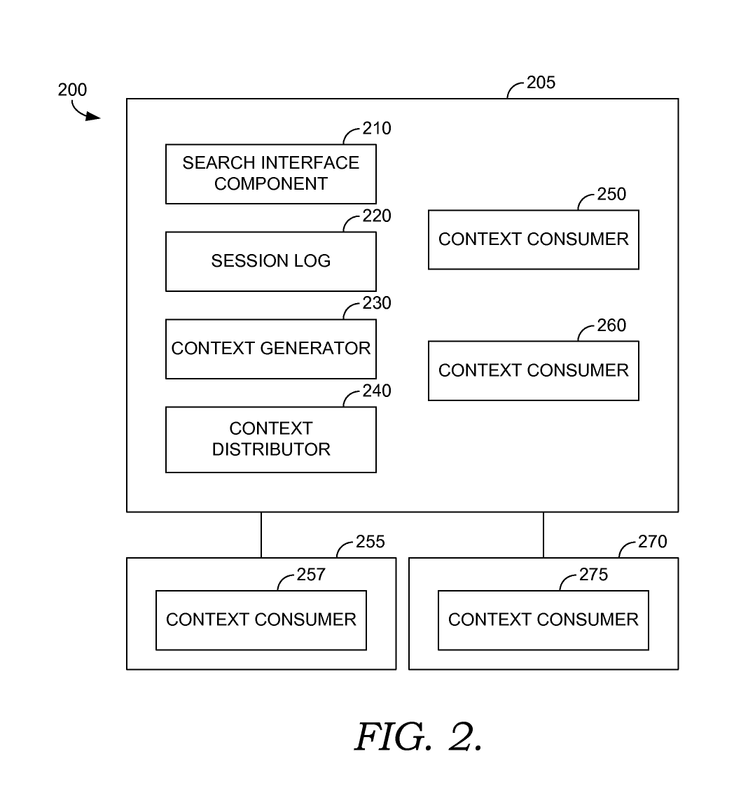

Turning now to FIG. 2, an exemplary computing system architecture 200 suitable for generating context characteristics describing a search session is provided, in accordance with an embodiment of the present invention. The computing system architecture 200 shown in FIG. 2 is an example of one suitable computing system architecture 200. The computing system architecture 200 runs on one or more computing devices similar to the computing device 100 described with reference to FIG. 1. The computing system architecture 200 should not be interpreted as having any dependency or requirement related to any single module/component or combination of modules/components illustrated therein. The computing system architecture 200 includes an search site 205, a user computing device 255, and a service-provider computing device 270. The search site 205 (alternatively described as a search engine) includes a search interface component 210, a session log 220, a context generator 230, a context distributor 240, a context-consumer application 250, and a context-consumer application 260. The user computing device 255 includes a context-consumer application 257. The service-provider computing device 270 includes context-consumer application 275. Throughout the description, the context-consumer applications 250, 257, 260, and 275, may collectively be described as a context consumer without reference to a particular instance. Each context consumer may perform different functions.

The search site 205 may be accessed by a user through a website provided by the search site 205. The user may use a web browser to navigate to a URL associated with the search site and enter a search query. The search site will provide one or more search results that are responsive to the search query. The search site 205 may also provide advertisements and other features. In one embodiment, the search site 205 provides different categories, or verticals, the user may select for searching. For example, the search site 205 may allow users to search for travel, shopping information, maps, books, or other categories of information. By selecting one of these categories, the user can limit the search results to those fitting into the selected category. As described in more detail subsequently, the selection of a search category may initiate a search session and can be one data point or signal used to determine a context for the search session. The search site 205 may include a web crawler that traverses one or more computer networks and catalogues documents encountered. These documents may be indexed for comparison with a search query.

The search interface component 210 generates an interface through which a search query may be submitted by a user. The search interface component 210 also presents a search-results interface and/or other search features. The search interface component 210 may allow the user to set preferences, modify a user profile, log-in, and otherwise facilitate communication of information between the user and the search site 205.

The session log 220 stores signals received during a search session. As stated, the signals are generated by user activities during the search session. A search session may be delineated by a starting event and an ending event. The starting event may be a user navigating to the search site 205's URL, entering a search query, selecting a search category, or other preliminary interaction with the search site. The search session may conclude after a threshold period of time passes without the user taking an action that is ascertained by the search site 205. In one embodiment, the threshold period of time is a half hour.

Signals received during the search session are logged by the session log 220. Examples of signals include search queries, search results generated in response to the search queries, user selection of a search result, expressions of user interests in a search result (wherein user interest is less than a selection of a search result, such as hovering over a search result), selection of a search category, information entered into a form, such as travel dates and locations in a travel vertical, and other inputs.

The context generator 230 analyzes the signal data within the session log 220 and assigns values to context characteristics that describe the search session. The “values” may be text, numbers, or a combination. The context characteristics include a location of interest. The location of interest may not be the user's present location, but a location mentioned in a search query, entered in a form, or associated with a selected search result. A geographic location, such as Kansas City, is an example value that may be assigned to the location-of-interest context characteristic. In one embodiment, multiple locations of interest may be assigned to the location-of-interest context characteristic.

The context characteristics also include a task intent. The task intent describes a real world task the user intends to accomplish during the search session. The user's actual intent or mental state is not needed to determine a task intent. Rather, the user's actions during this search session conform to a pattern of actions that are associated with a particular task intent. For example, a query including a consumer product may manifest an intent related to shopping. The task intent may be a broad category. For example, shopping may include an actual desire to purchase a consumer product online and researching consumer products without an actual intent to purchase the product online, or at all. Other examples of task intent include travel, planning a night out, financial planning, researching an entity, or research generally. In one embodiment, the task-intent context characteristic is assigned values from a plurality of predefined task intents. In other words, the context generator may select from shopping, travel, planning a night out, research, a sub-category of research, and other predefined task intent, rather that developing a description for new task intent.

The context generator 230 may also assign a value to an entities-of-interest context characteristic. Entities include people, sports teams, companies, politicians, celebrities, and other entities. The context generator 230 may recognize entities from a list of entities or identify entities based on usage patterns within text. A user's interests in an entity may be determined from the inclusion of an entity in a search query or a selection of a search result or navigation to a website associated with the entity. Additional context characteristics include task-specific data submitted by a user. Examples of task-specific data include travel dates, travel locations, geographic locations, and other similar data.

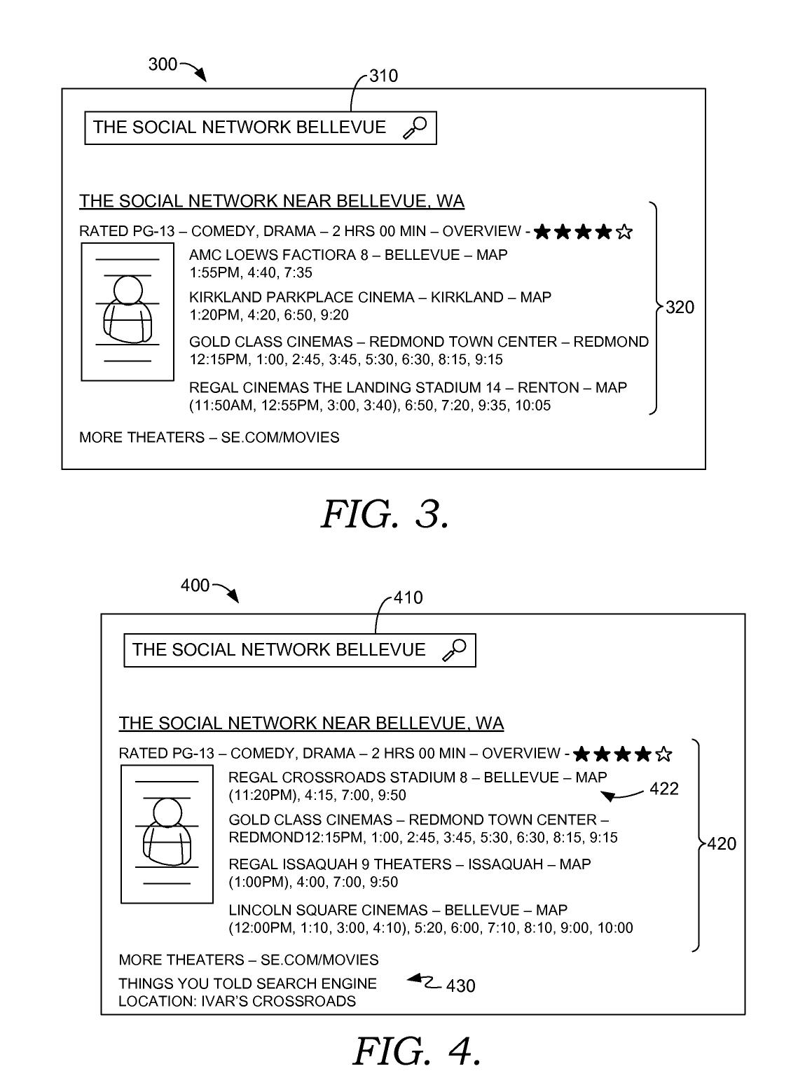

The context distributor 240 distributes the context characteristics and their associated values to one or more context consumers, such as context-consumer applications 250, 257, 260, and 275. As can be seen, the context consumers may be closely associated with the search site, such as context-consumer application 250 and context-consumer application 260. In another embodiment, the context consumers are remote from the search site 205 and may reside on a user's computing device 255 or a service provider's computing device 270. The context consumers may provide context-sensitive features based on the context characteristics. Examples these features are given in FIGS. 3-12.

The context distributor 240 may communicate the context characteristics to a context consumer upon satisfaction of a rule associated with an individual context consumer. For example, context-consumer application 250 may use context characteristics associated with a location of interest. Upon assigning a value to a location-of-interest context characteristic, the context distributor 240 may notify the context-consumer application 250 that this information is available. The context distributor 240 may directly communicate the context characteristics to the context-consumer application 250. In another embodiment, a context consumer periodically communicates with the context distributor 240 through an application program interface to retrieve current context characteristics.

The privacy of the context characteristics may be guarded by the context distributor 240 through use of encoding and other security methodologies to ensure that only authorized context consumers are given access to the context characteristics. Further, the values assigned to context characteristics are distinct from the original signal data. Thus, the context consumers do not need to analyze the raw signal data since they have useful context information to consume. Thus, the privacy of the signal data is preserved since it is not directly shared with context consumers. In one embodiment, the context characteristics are distributed to a context consumer under an agreement where the context distributor is compensated for the context characteristics based on the benefit received by a user's interaction with a search feature presented by the context consumer.

Turning now to FIGS. 3 and 4, the use of a “location of interest” to rank search results is illustrated, in accordance with an embodiment of the present invention. FIG. 3 shows search results 320 generated without using context characteristics to rank results based on proximity to a geographic location of interest. The search-results page 300 includes a query input box 310 with the search query “The Social Network Bellevue.” In response to this search query, search results 320 are shown. The search results 320 list theaters near Bellevue, Wash., that are showing the movie “The Social Network.”

Turning now to FIG. 4, enhanced search results 420 generated by adjusting a relevance rank based on a specific location of interest are shown, in accordance with an embodiment of the present invention. The search-results page 400 includes query input box 410 with the same search query as was shown in FIG. 3. In this case, the signal data for the search session expresses an interest in Ivar's Crossroads, which is a shopping district near Bellevue, Wash. The user may have expressed this interest by clicking on a website associated with a restaurant in Ivar's Crossroads or entering a search query, such as “restaurants near Ivar's Crossroads.” Other ways of expressing interest in this location are possible. The signal was analyzed and a value of Ivar's Crossroads was assigned to the location-of-interest context characteristic.

The location of interest is communicated to a context consumer that ranks search results in terms of relevance by taking into account a proximity to a geographic location of interest. In this case, the search result 422 is the closest theater to Ivar's Crossroads. Note that this search result 422 did not even show up in the previous top four search results 320 shown on search-result page 300.

In this case, the context information 430 is shown on the search-results page 400. In one embodiment, the context characteristics are not displayed to the user. In embodiments where they are displayed to the user, the user may be presented with an option to reset or change the context characteristics.

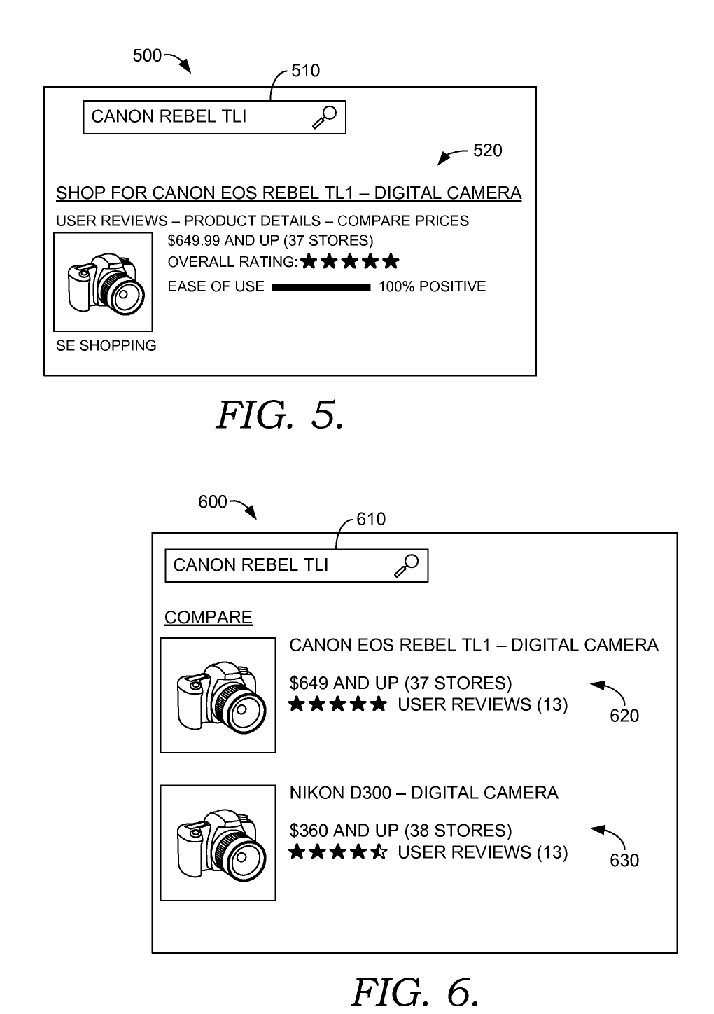

Turning now to FIGS. 5 and 6, use of context characteristics to provide a consumer product comparison is shown, in accordance with an embodiment of the present invention. FIG. 5 shows a search-results page 500 with normal search results. The search-results page 500 includes a query inbox 510 with the search query “Canon Rebel TL1.” In this case, a single search result 520 for the Canon Eos Rebel TL1 is shown.

Turning now to FIG. 6, a comparison-shopping feature generated with context characteristics is shown, in accordance with an embodiment of the present invention. The search-results page 600 includes a query input box 610 with the same search query as shown in FIG. 5. In this case, the context information may include a task intent of shopping and a task-intent data value of a Nikon D300. These context characteristics are communicated to an application that generates a comparison search result. The comparison search result shown on search-results page 600 includes a search result 620 and 630 for both the Canon and Nikon cameras with some of the same pertinent information displayed for the sake of comparison.

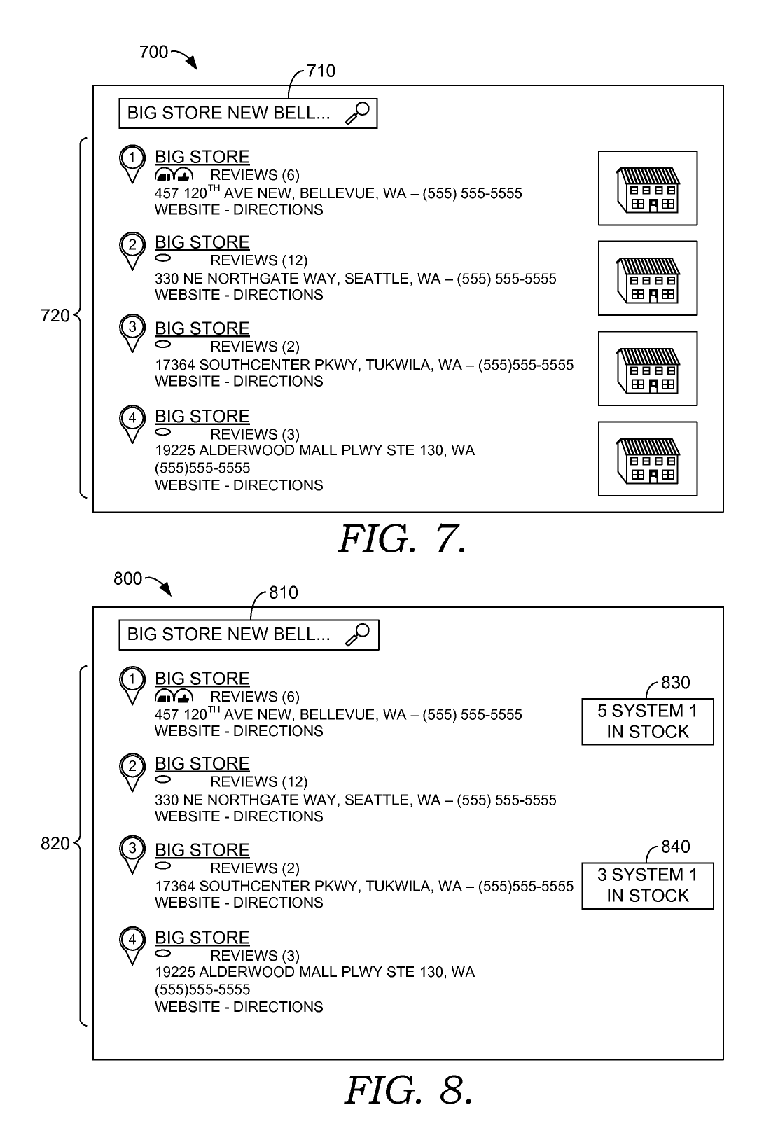

Turning now to FIGS. 7 and 8, an in-stock feature that utilizes context characteristics is illustrated, in accordance with an embodiment of the present invention. FIG. 7 shows a search-results page 700 generated without the use of context characteristics. The search input box 710 includes a search query “big store near Bellevue.” The search results 720 show four locations of “big store” near Bellevue.

Turning now to FIG. 8, search results enhanced by an in-stock context-sensitive feature are shown, in accordance with an embodiment of the present invention. The query input box 810 includes the same “big store near Bellevue” query as was shown in FIG. 7. Based on previous signal data, the context characteristics associated with the present search session include a “task intent” of shopping and task-specific data for the Game System 1 (a proper name for a fictional game system). In this case, the signal data could be a single query for the Game System 1. This context information is passed to an in-store search results feature that is able to display how many Game System 1 are in stock at two of the stores. The first store shows that five Game System 1s are in stock 830 at the first store and three Game System 1s are in stock 840 at the third store. Thus, the in-stock feature anticipates that the user is shopping for a particular product and provides inventory for stores appearing in search results.

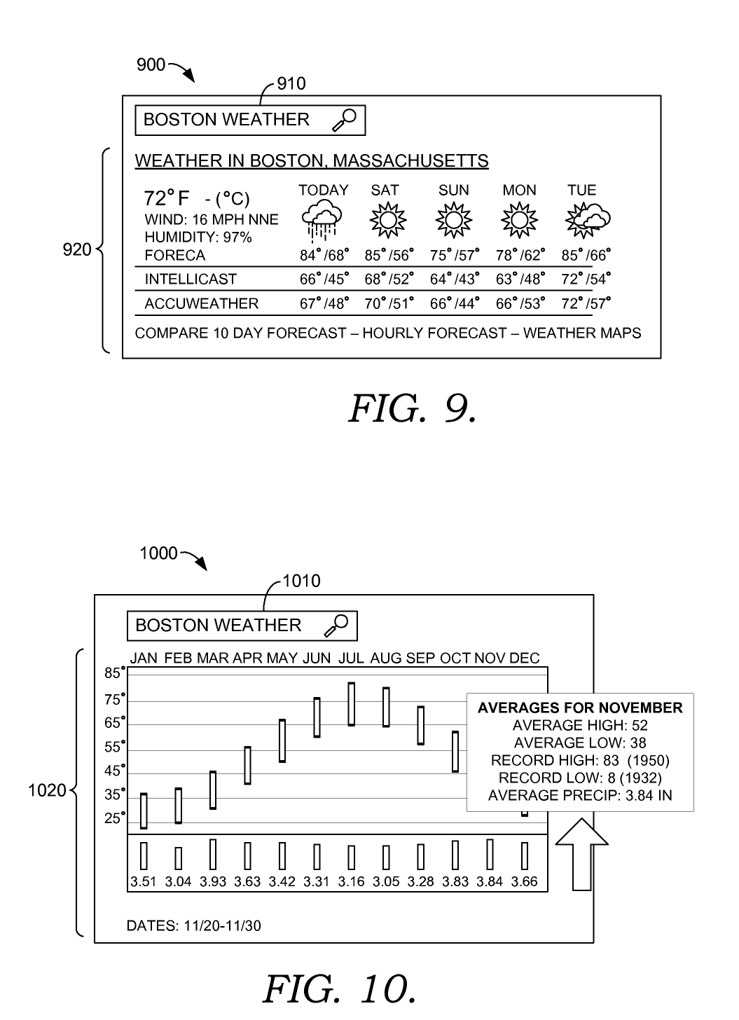

Turning now to FIGS. 9 and 10, the use of a travel date to modify weather results is illustrated, in accordance with an embodiment of the present invention. FIG. 9 illustrates typical weather results generated without use of context characteristics, in accordance with an embodiment of the present invention. The weather results page 900 includes a query input 910 for “Boston weather.” The weather results 920 show a current ten-day forecast for Boston.

Turning now to FIG. 10, context-sensitive weather results are shown, in accordance with an embodiment of the present invention. The weather results page 1000 includes the same query “Boston weather” within query input box 1010 that was shown in FIG. 9. In this case, context characteristics associated with a date of travel of November 20-November 30 are passed to the context consumer, which in this case is a weather results application. The weather results 1020 show average temperatures for the dates in question and actually for the entire year. This example presumes that the dates in question do not fall within the current ten-day forecast. Instead, more general weather information is provided since it is more likely to be what the user is seeking.

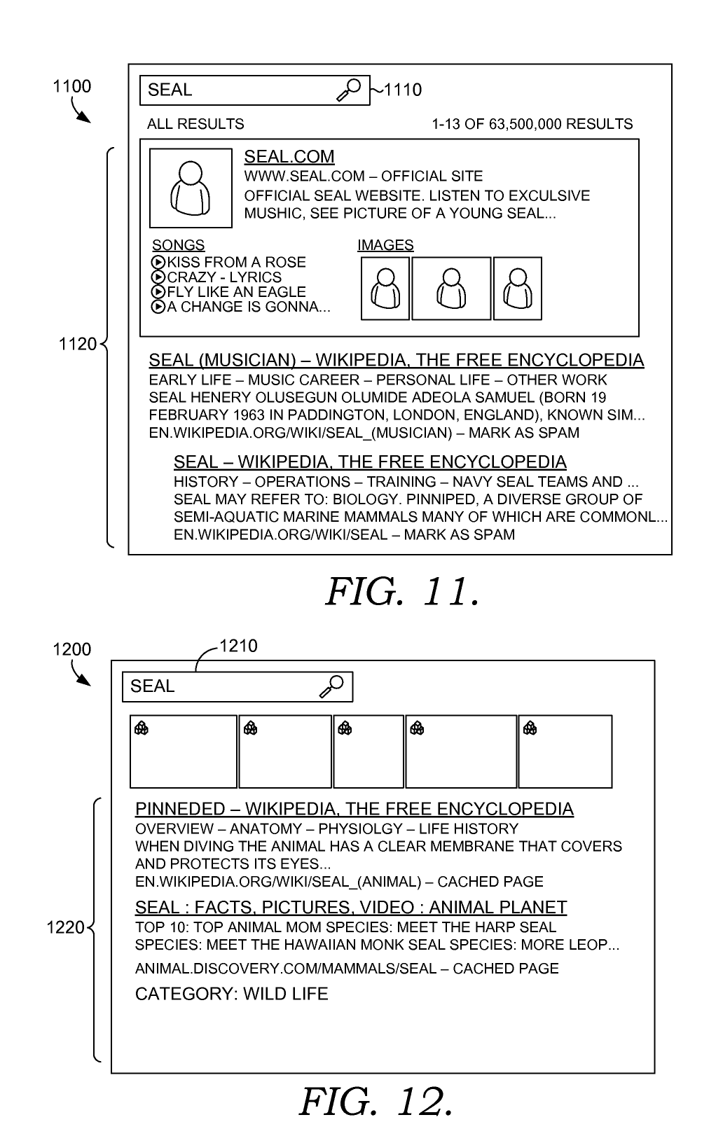

Turning now to FIGS. 11 and 12, the use of context characteristics in search query disambiguation is illustrated. In FIG. 11, standard search results 1120 are shown in response to the query “Seal” entered in search input box 1110. As can be seen, the search results 1120 relate to the musician Seal.

Turning now to FIG. 12, disambiguated query results 1220 for the query “seal,” which is entered in search input box 1210 are shown. In this case, the search results 1220 relate to the animal seal, not the artist. Context information from the search session is used by a disambiguation application to generate these search results. In this case, the signal data includes a previous search query for “World Wildlife Fund” and “endangered animals.” This signal data was used to populate a category of interest with “wildlife.” A category of interest is another example of a context characteristic. Thus, the query disambiguation application was able to know, based only on context from the current search session, that the user is more likely to be interested in the animal seal than the artist Seal. In one embodiment, the disambiguation application does not need to analyze the search history and was not provided the search history to perform this disambiguation. Rather, the query-disambiguation application was provided with the context information, which had been previously ascertained by a context generator, such as context generator 230.

The same context information may be shared with multiple context consumers that use the context characteristics for different purposes related to search results. The current context information may change as new signals are received.

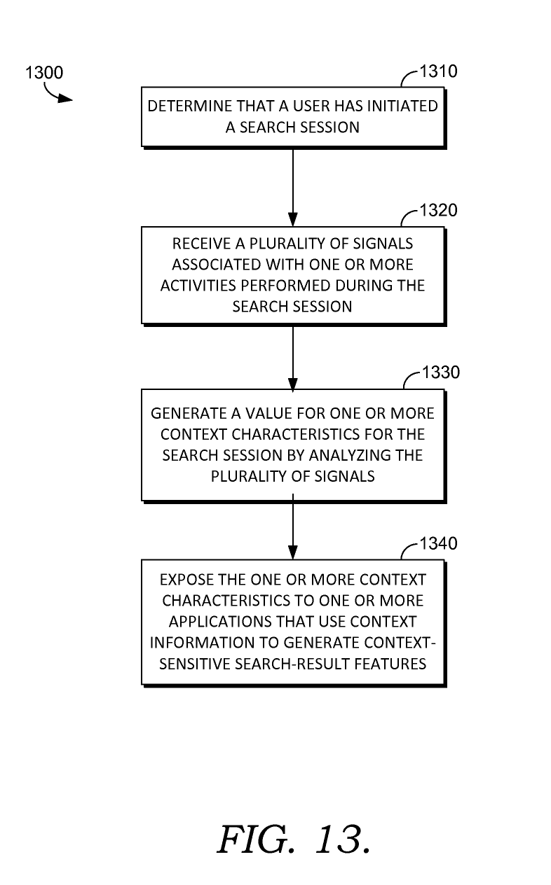

Turning now to FIG. 13, a method 1300 of developing context information based on signals received during a search session is shown, in accordance with an embodiment of the present invention. The method 1300 may be performed on one or more computing devices. The computing devices may be associated with a search entity that operates a search site or search engine.

At step 1310, a user is determined to have initiated a search session. The search session is a series of user activities associated with online searching. The search session may be bounded by a starting event and a terminating event. The starting event may be detection of a user activity through a search interface associated with a search engine. Example activities include entering a search query, logging in to a search site, selecting a search category, and clicking on a link from a search site. The terminating event may be a lapse of activity. For example, the terminating event may occur when no ascertainable user activity occurs for a threshold duration of time.

At step 1320, a plurality of signals are received during the search session. The plurality of signals may be stored for the duration of the search session. The plurality of signals are derived from activities that occur during a search session. Example signals include a search query, selection of a search category, interaction with a search result, navigating to a website, interaction with an advertisement. Embodiments of the present invention are not limited to these examples of user signals; other signals associated with user activities can be used.

At step 1330, one or more values for context characteristics are generated for the search session by analyzing the plurality of signals. In one embodiment, only signals generated as part of the search session are used. In other words, signals such as prior browsing history, user interests, user profile data, and prior search history, which occurred apart from the current search session, may be excluded from the analysis used to generate the values. A user may adjust privacy settings that limit the signals used or collected by an application generating the one or more values. Examples of context characteristics have been given previously but include a location of interest, a subject matter category of interest, a task intent, an entity of interest, and task-specific data. A location of interest is a location described by the signal data. The location of interest may be independent of a user's present location. For example, a user could be conducting a search session in Dallas, Tex., and expressing an interest in Los Angeles, Calif.

A subject matter category of interest may be discerned from common subject matter in multiple searches or even a single search. For example, a search for the “World Wildlife Fund” may express a subject matter interest in wildlife, environmental interests, and politics. An individual context characteristic may be associated with multiple values. Each of the multiple values may be associated with a confidence factor. For example, upon receiving the single search “World Wildlife Fund,” various confidence factors may be assigned to the subject matter category of wildlife, environment, and politics. The confidence factor indicates a probability that the search session is related to the subject matter category. Receiving a subsequent search for elephants may change the relative confidence factors. For example, the confidence factor associated with wildlife may increase and the confidence factor related to politics or the environment may decrease. Similar confidence factors may be assigned to values in context categories. For example, locations of interest may each have different confidence factors. For example, there may be a high-confidence factor associated with Bellevue, Wash., but a lower-confidence factor associated with an area of Bellevue, Wash., such as Ivar's Crossroads.

Additional context characteristics include an intended task, also described herein as a task intent. Task-specific data may be collected as a context characteristic. Data entered into forms, such as travel dates, travel locations, and other factors, are included within task-specific data. Task-specific data may also include data that is received in a search query or extracted from a search result, or website. For example, key words associated with a website to which the user navigates may be recorded as task-specific data. Task-specific data may be recorded when a rule identifies information that may be useful to one or more context consumers. Existing context characteristics may be used to determine whether information should be included in a task-specific data. For example, when the task-intent is set to shopping, consumer products identified in the search query or listed on web pages may be added to the task-specific data. When the task-intent is set to travel, the consumer product information may not be assigned values within the task-specific data since it is unlikely to be useful in relation to travel intent. When the task-intent is set to planning a night out information relative to planning a night out, such as date of night out, location of night out, activities of interest to the user, may be stored as a task-specific data as the search session progresses. This data may be used to suggest nearby bars, movies, events, etc. The search results could show restaurant hours, coupons, etc. by using. The search results ranking of bars that are closed after an event in which a user expresses interest could be lowered.

The one or more context characteristics may change as a search session progresses. In one embodiment, upon receiving search signals that are inconsistent with one or more current context characteristics, weight given to previously received signals in the determination of context characteristics is decreased. Receiving a signal that is inconsistent with current context characteristics may indicate that a user's intent for the search session has changed. For example, if the current signals are all associated with shopping for an automobile, a search query for “head lice cures” may be identified as incongruent with the previous search signals and the current context characteristics generated from those signals. In one embodiment, upon receiving such an incongruent signal, the context characteristics are reset and regenerated based on only new signals. In another embodiment, more weight is given to new signals, but old signals are also considered when making context characteristic determinations. An incongruent or contradictory signal may mark the end of one search session and the beginning of a new search session.

The context characteristics may be generated using a series of heuristics. The heuristics may be rules that are satisfied by various signals. An example of a simple heuristic is a rule that populates a location of interest when a geographic location occurs in a search query. In another embodiment, machine-learning algorithms are used to recognize patterns in the signal data that correspond to various context characteristics.

At step 1340, one or more context characteristics and associated values are exposed to one or more applications that use context information to generate context-sensitive features. The context characteristics may be exposed by directly communicating them to consuming applications. In addition to exposing the one or more context characteristics, the current search query may also be exposed or communicated to the context-consuming applications. In another embodiment, the context-consuming applications retrieve the context characteristics from a search engine or other component generating the context characteristics. In one embodiment, the search engine or component generating the context characteristics notifies certain applications that context characteristics have been generated when the generated context characteristics are of a type consumed by the application. In one embodiment, a user is able to set user preferences that limit what context information can be exposed. Examples of applications that consume the context characteristics have been described previously with reference to FIGS. 3-12.

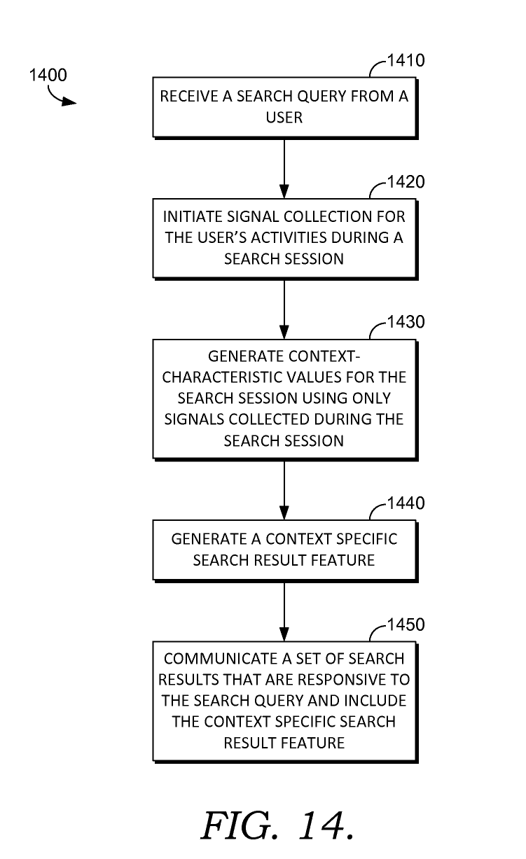

Turning now to FIG. 14, a method of providing context-sensitive features is described, in accordance with an embodiment of the present invention. Method 1400 may be performed on one or more computing devices associated with a search engine or a search site. At step 1410, a search query is received from a user. This may indicate the initiation of a search session. Examples of other user activities that may indicate the initiation of a search session have been described previously. At step 1420, signal collection for the user's activities is initiated during the search session. Examples of signals have been described previously. The signals may be stored for the duration of a user's search session.

At step 1430, context-characteristic values for the search session are generated using only signals collected during the search session. In this embodiment, other information known about the user is excluded from the generation of context-characteristic values. Examples of context characteristics have been described previously. In one embodiment, multiple values for individual context characteristics may be generated. In another embodiment, only a value with the highest probability of reflecting a search session's intent is generated for an individual context characteristic value.

At step 1440, a context-sensitive feature using the context characteristics is generated. Examples of context-sensitive features have been described previously with reference to FIGS. 3-12.

At step 1450, a set of search results that are responsive to the search query and include the context-sensitive feature is communicated. The search-result feature and search results may be displayed through a user interface accessed through a web browser. The context-sensitive feature may be generated by an application associated with a search site or a search engine. The feature may also be generated by an application associated with an advertiser, consumer entity, or other entity interested in providing search results to a user. The application generating the feature may reside on the user's computing device, for example, as a plug-in to a web browser.

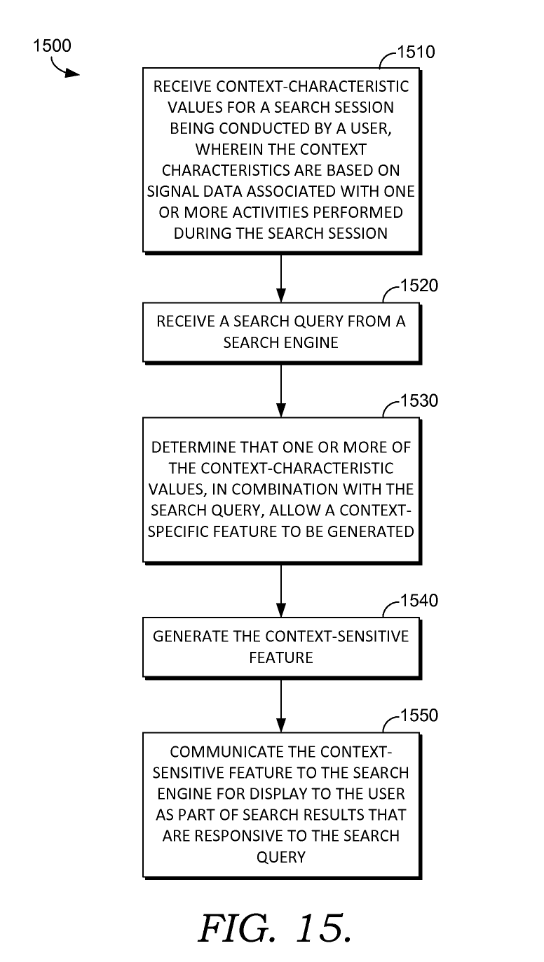

Turning now to FIG. 15, a method of generating context-sensitive features using context characteristics of a search session is described, in accordance with an embodiment of the present invention. Method 1500 may be performed on one or more computing devices associated with a search site or a search engine.

At step 1510, context characteristics of a search session being conducted by a user are received. The context characteristics are based on signal data associated with one or more activities performed during the search session. The context characteristics may be received by an entity associated with a search engine that generates the context characteristics. The context characteristics may be received by an application residing on the user's computing device, an advertiser's computing device, or a search engine's computing device. Examples of context characteristics have been described previously. In one embodiment, multiple values may be associated with individual context characteristics. For example, multiple locations of interest may be communicated as context characteristics. In another embodiment, only a single value for each context characteristic is received. The single value may be the value having the highest associated confidence factor.

At step 1520, a search query is received from a search engine. In one embodiment, the search engine communicates the search query in conjunction with the context characteristics received at step 1510.

At step 1530, one or more context-characteristic values are determined to allow a context-sensitive feature to be generated in combination with the search query. In other words, enough useful context characteristics are determined to exist to generate the desired context-specific feature. For example, the relevance ranking based in part upon proximity to a location of interest described with reference to FIGS. 3 and 4 needs a query that produces search results with a geographic component and a value for the location-of-interest context characteristic. Without both, that particular feature may not be available.

At step 1540, the context-sensitive feature is generated. At step 1550, a context-sensitive feature is communicated to the search engine for display to the user as part of search results that are responsive to the search query. In one embodiment, the feature is communicated in the form of data that can then be populated into a known format by the search engine's display component. In another embodiment, the format for the search-result feature is also provided.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable storage media having computer-executable instructions embodied thereon that when executed by a computing device perform a method of developing context information based on signals received during a search session, the method comprising:
determining that a user has initiated a search session, wherein the search session comprises a series of activities associated with online searching of Internet content;
receiving a plurality of signals associated with one or more activities performed during the search session;
generating, at the computing device, a value for one or more context characteristics for the search session by analyzing the plurality of signals; and
exposing the one or more context characteristics and associated values to one or more applications that use context information to generate a context-sensitive feature.

2. The media of claim 1, wherein the method further comprises storing the plurality of signals for a duration of the search session.

3. The media of claim 2, wherein the one or more activities is only search queries received during the search session, and wherein the plurality of signals are words from the search queries.

4. The media of claim 1, wherein the one or more context characteristics comprise a location of interest to the user, a task the user intends to complete, task-specific data, travel dates, travel origin, and travel destination, and entity data that describes entities identified during the search session.

5. The media of claim 1, wherein the method further comprises determining that the search session terminated, and wherein the search session is initiated when a user navigates to an online search web site, and the search session is terminated after a threshold duration of time passes without the user taking actions that are ascertainable by the search web site.

6. The media of claim 1, wherein the method further comprises determining that an application is interested in the one or more context characteristics and communicating at least one of the one or more context characteristics to the application.

7. The media of claim 1, wherein the one or more context characteristics are exposed through a web service or application program interface, wherein the application periodically retrieves the one or more context characteristics to determine if the application is able to provide specialized context-sensitive features using the one or more context characteristics.

8. A method of providing context-sensitive features, the method comprising:
receiving a search query from a user;
initiating signal collection for the user's activities during a search session;
generating, at a computing device, context-characteristic values for the search session using only signals collected during the search session;
generating, at a computing device, a context-sensitive feature using the context-characteristic values; and
communicating a set of search results that are responsive to the search query and include the context-sensitive feature.

9. The method of claim 8, wherein the context-sensitive feature is a side-by-side comparison between two or more entities at least one of which is included in the search query.

10. The method of claim 9, and wherein the side-by-side comparison is initiated when the context characteristics indicate the user is completing a shopping related task, wherein the two or more entities are comparable products, and wherein the two or more entities include a product explicitly included in the search query.

11. The method of claim 8, wherein the context-characteristic values describe one or more of a location of interest to the user, a task the user intends to complete, and entity data, wherein the entity data describes entities identified during the search session.

12. The method of claim 8, wherein the method further comprises communicating the context-characteristic values to an application that generates additional context-sensitive features using the context-characteristic values.

13. The method of claim 8, wherein the method further comprises receiving signals from an application that generates additional context-sensitive features.

14. The method of claim 8, wherein the context-sensitive feature is a set of search results based on a query disambiguated using the context-characteristic values.

15. The method of claim 8, wherein the context-sensitive feature is a set of search results tailored to a location of interest that is identified in the context-characteristic values.

16. One or more computer-readable storage media having computer-executable instructions embodied that when executed by a computing device perform a method of generating context-sensitive features using context characteristics of a search session, the method comprising:
receiving context-characteristic values for a search session being conducted by a user, wherein the context-characteristic values are based on signal data associated with one or more activities performed during the search session;
receiving a search query from a search engine;
determining that one or more of the context characteristic values, in combination with the search query, allow a context-specific feature to be generated;
generating, at the computing device, the context-sensitive feature;
communicating the context-sensitive feature to the search engine for display to the user as part of search results that are responsive to the search query.

17. The media of claim 16, wherein the method further comprises communicating signal data collected as a result of the user interacting with the context-sensitive feature to the search engine.

18. The media of claim 16, wherein the context characteristics are received as a result of the search engine determining an application that generated the context-sensitive feature is able to constructively consume the context characteristics to generate the context-sensitive feature.

19. The media of claim 16, wherein an application that generates the context-sensitive feature receives the context characteristics by retrieving the context characteristics from the search engine.

20. The media of claim 16, wherein the context characteristics are provided to an application that generates the context-sensitive feature in exchange for compensation based on the user's interactions with the context-sensitive feature.
